(19) United States
(12) Patent Application Publication
(10) Pub. No.: US 2012/0173182 A1
(43) Pub. Date: Jul. 5, 2012

(54) METHOD FOR CALIBRATING OSCILLOSCOPES

(75) Inventors: HSIEN-CHUAN LIANG, Tu-Cheng (TW); SHEN-CHUN LI, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/286,081

(22) Filed: Oct. 31, 2011

(30) Foreign Application Priority Data
Dec. 29, 2010 (TW) 099146729

(51) Int. Cl. G06F 19/00

(52) U.S. Cl. 702/85

(57) ABSTRACT

A method calibrates a second oscilloscope according to setting values of a first oscilloscope. The setting value of the first oscilloscope is stored into a first file which is readable by any oscilloscope, and also into a second file. Test data obtained from testing an electronic signal using the first oscilloscope is stored into a third file, and waveform data obtained from testing the electronic signal are stored into a fourth file. The second oscilloscope acquires the first file, the second file, the third file, and the fourth file to reset the setting value of the second oscilloscope to the same as the setting value of the first value, for reproducing the test data of the third file and the waveform data of the fourth file.

### BACKGROUND

1. Technical Field

Embodiments of the present disclosure relate to methods of signal testing, and more particularly to a method for calibrating a second oscilloscope for reproducing test data generated by a first oscilloscope.

2. Description of Related Art

Oscilloscopes are instruments for testing certain qualities of electronic signals, and indicating and recording test data including time-varying electrical quantities, such as current and voltage, of the electronic signals. The time-varying electrical quantities can be used to help evaluate qualities of the electronic signals. Because preset values, such as a trigger and a sample rate of acquiring electronic signals, a record length and a resolution of electronic signals of different oscilloscopes may be different, test data from a first oscilloscope may be distorted when displayed on a second oscilloscope, thus, it is hard to accurately reproduce the time-varying electrical quantities of an electronic signal on different oscilloscopes.

### BRIEF DESCRIPTION OF THE DRAWINGS

FIG. 1 is a block diagram of one embodiment of an electronic device comprising an oscilloscope data processing system.

FIG. 2 is a block diagram of one embodiment of function modules of the oscilloscope data processing system in the electronic device of FIG. 1.

FIG. 3 and FIG. 4 are flowcharts of one embodiment of a method for calibrating an oscilloscope.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

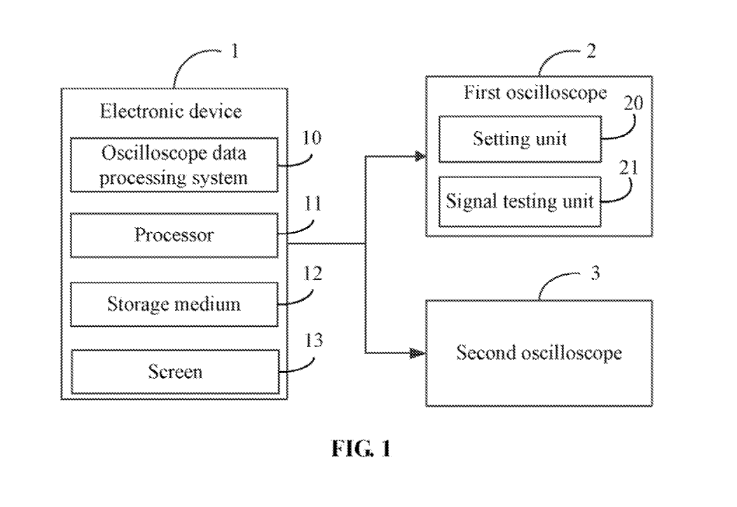

FIG. 1 is a block diagram of one embodiment of an electronic device 1 comprising an oscilloscope data processing system 10. In the embodiment, the electronic device 1 further includes at least one processor 11, a non-transitory storage medium (hereinafter, storage medium) 12, and a screen 13. Depending on the embodiment, the storage medium 12 may be a hard disk drive, a compact disc, a digital video disc, a tape drive or other suitable storage mediums.

The electronic device 1 is connected with a first oscilloscope 2 and a second oscilloscope 3. In one embodiment, the first oscilloscope 2 includes a setting unit 20, and a signal testing unit 21. The setting unit 20 receives setting values of the first oscilloscope 2. The setting values of the first oscilloscope 2 may be input by a user via an interface (not shown) of the first oscilloscope 2. The setting values may include, such as, a trigger and a sample rate of acquiring electronic signals, a record length and a resolution of the acquired electronic signals.

The signal testing unit 21 tests an electronic signal to generate test data and waveform data of time-varying electrical quantities of the electronic signal. The electronic signal may be emitted from an electronic circuit board (not shown), which is connected with the first oscilloscope 2. In the present embodiment, the test data includes numerical electrical quantities of the electronic signal.

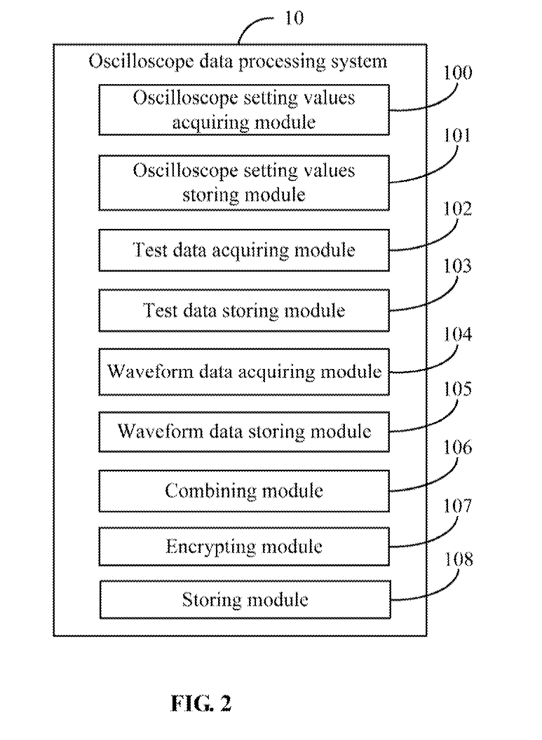

The oscilloscope data processing system 10 includes a number of function modules (depicted in FIG. 2). The function modules may comprise computerized code in the form of one or more programs that are stored in the storage medium 12. The computerized code includes instructions that are executed by the at least one processor 11, to process data of the first oscilloscopes 2, including the setting values of the first oscilloscope 2, the test data and waveform data of the electronic signal generated by the first oscilloscope 2, so as to calibrate the second oscilloscope 3, to enable the second oscilloscope 3 to have the same setting values as the first oscilloscope 2, thus, to enable the accurate reproduction of the test data and the waveform data generated by the first oscilloscope 2 on the second oscilloscope 3.

In one embodiment, the electronic device may be a computers, a server, a smart phones, and a personal digital assistant (PDA). In other embodiment, the electronic device 1 and the first oscilloscope 2 may be integrated, namely, the oscilloscope data processing system 10, the processor 11, and the storage medium 12 may be integrated into the first oscilloscope 2.

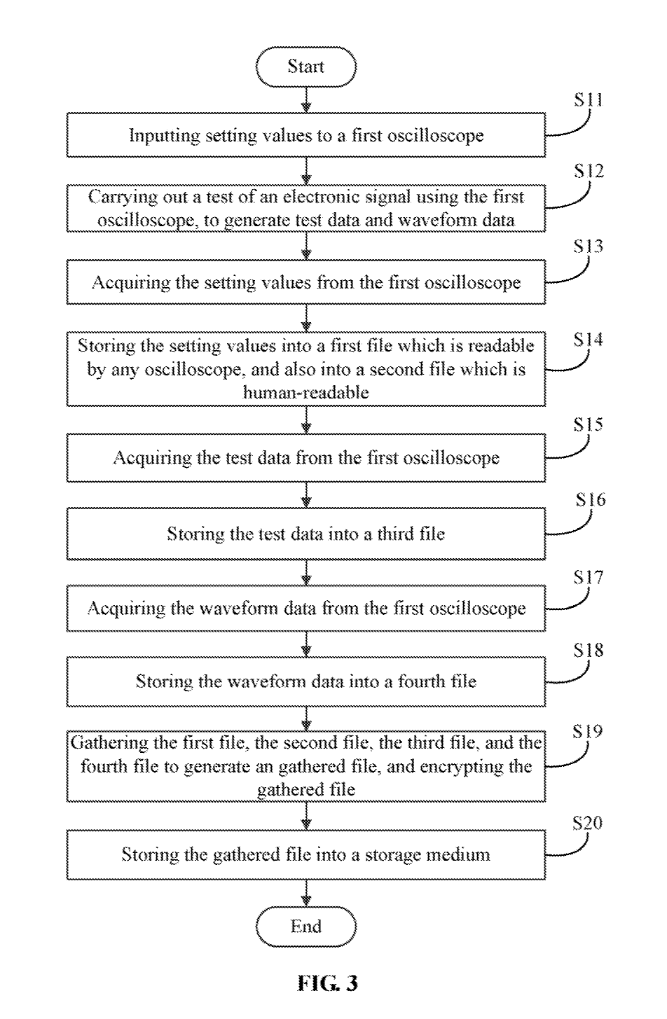

FIG. 2 is a block diagram of one embodiment of the function modules of the oscilloscope data processing system 10. In one embodiment, the oscilloscope data processing system 10 may include the function modules of, for example, an oscilloscope setting values acquiring module 100, an oscilloscope setting values storing module 101, a test data acquiring module 102, a test data storing module 103, a waveform data acquiring module 104, a waveform data storing module 105, a combining module 106, an encrypting module 107, and a storing module 108. The function modules 100-108 may provide the functions mentioned below (illustrated in FIG. 3).

FIG. 3 is a flowchart of one embodiment of a method for processing data from the first oscilloscope 2, whereby a combined file may be generated. Depending on the embodiment, additional blocks may be added, others removed, and the ordering of the blocks may be changed.

In block S11, the setting unit 20 of the first oscilloscope 2 receives setting values of the first oscilloscope 2. As mentioned, the setting values may be input by a user from an interface (not shown) of the first oscilloscope 2. The setting values may include, such as, a trigger and a sample rate of acquiring electronic signals, a record length and a resolution of the acquired electronic signals.

In block S12, the signal test unit 21 of the first oscilloscope 2 carries out a test(s) of an electronic signal to generate test data and waveform data of time-varying electrical quantities of the electronic signal. As mentioned above, the electronic signal may be emitted from an electronic circuit board (not shown) which is connected with the first oscilloscope 2.

In block S13, the oscilloscope setting values acquiring module 100 acquires the setting values from the first oscilloscope 2. As mentioned, The setting values may include, such as, a trigger and a sample rate of acquiring electronic signals, a record length and a resolution of the acquired electronic signals. In block S14, the oscilloscope setting values storing module 101 stores the setting values into a first file which is only readable by any oscilloscope, and also into a second file which is readable by many kinds of electronic devices, such as computers, servers, smart phones, and PDAs. In one embodiment, the first file may be in a .WFM format or a .CSV format, and the second file may be in, for example, a .BMP format, or a .XLS format.

In block S15, the test data acquiring module 102 acquires the test data of testing of the electronic signal from the first oscilloscope 2. As mentioned above, the test data includes numerical quantities in relation to the electronic signal. In block S16, the test data storing module 103 stores the test data into a third file. In one embodiment, the third file may be in a .WFM format or a .CSV format.

In block S17, the waveform data acquiring module 104 acquires the waveform data of testing of the electronic signal from the first oscilloscope 2, and in block S18, the waveform data storing module 105 stores the waveform data into a fourth file. In one embodiment, the fourth file may be in a .JPEG format, or a .BMP format.

In block S19, the combining module 106 combines the first file, the second file, the third file, and the fourth file into a single combined file (the combined file hereinafter), and the encrypting module 107 encrypts the combined file.

In block S20, the storing module 108 stores the combined file into the storage medium 12 of the electronic device 1. The combined file can also be stored in the storage medium of the first oscilloscope 2.

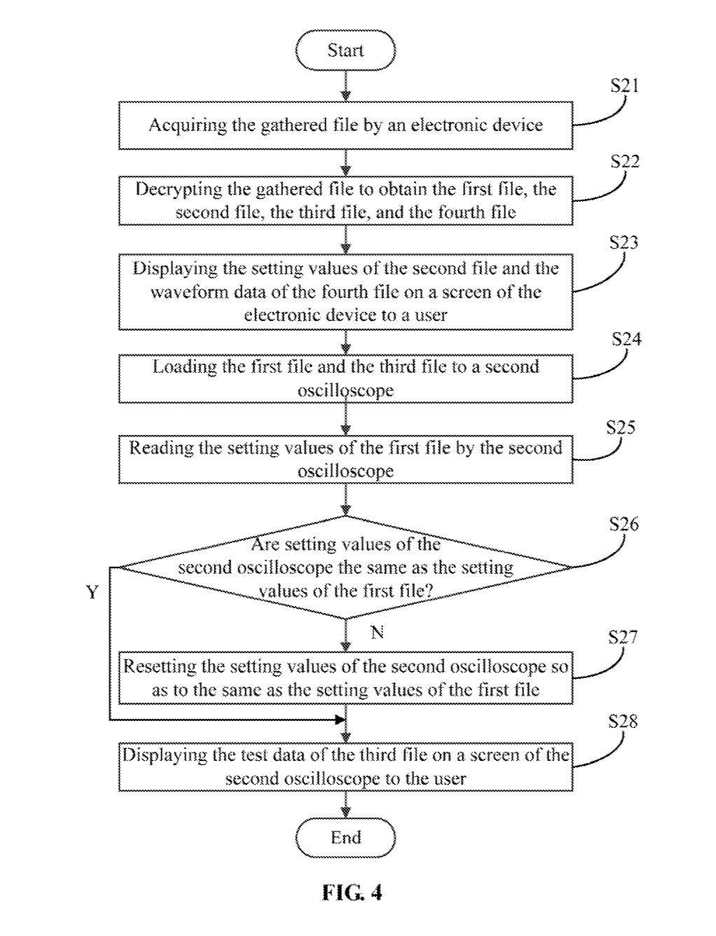

FIG. 4 is a flowchart of one embodiment of a method of calibrating a second oscilloscope 3 using the method (in FIG. 3) whereby the combined file may be created. Depending on the embodiment, additional blocks may be added, others removed, and the ordering of the blocks may be changed.

In block S21, an electronic device (may be the electronic device 1 or any other electronic device) acquires the combined file from the storage medium 12 of the electronic device 1 or from the storage medium of the first oscilloscope 2.

In block S22, the electronic device decrypts the combined file to obtain or recreate the first file, the second file, the third file, and the fourth file.

In block S23, the electronic device displays the setting values of the second file and the waveform data of the fourth file to the user via a screen 13 of the electronic device. As mentioned above, the second file may be in, for example, a .BMP format, or a .XLS format, which can be readable by many kinds of electronic devices, such as computers, smart phones, and PDA, and the fourth file may be in, for example, a .JPEG format, or a .BMP format, which can be also readable by many kinds of electronic devices. Thus, the user can directly read the setting values of the second file and the waveform data of the fourth file using the electronic device.

In block S24, the electronic device loads the first file and the third file to the second oscilloscope 3. As mentioned above, both the first file and the third file be in a .WFM format or a .CSV format, which is oscilloscope-readable. Other electronic device, such as a computer, can not read the first file and the third file having a .WFM format or a .CSV format.

In block S25, the second oscilloscope 3 reads the setting values of the first file, and in block S26, the second oscilloscope 3 determines if the setting values of the second oscilloscope are the same as the setting values of the first file. Block S27 is implemented if the setting values are different, or block S28 is implemented if the setting values are the same.

In block S27, the second oscilloscope 3 resets the setting values of the second oscilloscope to be the same as the setting values of the first file.

In block S28, the second oscilloscope 3 displays the test data of the third file to the user via a screen (not shown) of the second oscilloscope. Because the setting values of the second oscilloscope 3 are the same as the setting values of the first oscilloscope 2, thus, the test data generated by the first oscilloscope 1 can be accurately reproduced on the second oscilloscope 3.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of calibrating an oscilloscope, the method being performed by a processor of an electronic device, and comprising:
acquiring setting values of a first oscilloscope, and storing the setting values into a first file and also into a second file;
acquiring test data resulting from test of an electronic signal from the first oscilloscope, and storing the test data into a third file, wherein the test data comprises numerical electrical quantities of the electronic signal;
acquiring waveform data resulting from test of the electronic signal from the first oscilloscope, and storing the waveforms into a fourth file;
combining the first file, the second file, the third file, and the fourth file into a combined file; and
storing the combined file into a non-transitory storage medium.

2. The method according to claim 1, wherein the non-transitory storage medium is positioned in the first oscilloscope or in the electronic device.

3. The method according to claim 1, wherein the electronic device is the first oscilloscope.

4. The method according to claim 1, wherein the setting values comprise a trigger and a sample rate of acquiring electronic signals, a record length and a resolution of the acquired electronic signals.

5. The method according to claim 1, before the storing step, further comprising:
encrypting the combined file.

6. The method according to claim 1, wherein the first file and the third file are in a .WFM format or a .CSV format, and the second file and the fourth file are in a .BMP format, or a .XLS format.

7. The method according to claim 6, further comprising:
displaying the setting values of the second file and the waveform data of the fourth file to a user via a screen of the electronic device;
loading the first file and the third file to a second oscilloscope;
reading the setting values of the first file by the second oscilloscope to determine if the setting values of the second oscilloscope are the same as the setting values of the first file by comparison;
resetting the setting values of the second oscilloscope to be the same as the setting values of the first file; and
displaying the test data of the third file to the user via a screen of the second oscilloscope.

8. A non-transitory storage medium having stored thereon instructions that, when executed by a processor of an electronic device, causes the processor to perform a method of calibrating an oscilloscope, the method comprising:
acquiring setting values of a first oscilloscope, and storing the setting values into a first file and also into a second file;
acquiring test data resulting from test of an electronic signal from the first oscilloscope, and storing the test data into a third file, wherein the test data comprises numerical electrical quantities of the electronic signal;
acquiring waveform data resulting from test of the electronic signal from the first oscilloscope, and storing the waveforms into a fourth file;
combining the first file, the second file, the third file, and the fourth file into a combined file; and
storing the combined file into a non-transitory storage medium.

9. The non-transitory storage medium according to claim 8, wherein the non-transitory storage medium is positioned in the first oscilloscope or in the electronic device.

10. The non-transitory storage medium according to claim 8, wherein the electronic device is the first oscilloscope.

11. The non-transitory storage medium according to claim 8, before the storing step, further comprising:
encrypting the combined file.

12. The non-transitory storage medium according to claim 8, wherein the setting values comprise a trigger and a sample rate of acquiring electronic signals, a record length and a resolution of the acquired electronic signals.

13. The non-transitory storage medium according to claim 8, wherein the first file and the third file are in a .WFM format or a .CSV format, and the second file and the fourth file are in a .BMP format, or a .XLS format.

14. The non-transitory storage medium according to claim 13, wherein the method further comprising:
displaying the setting values of the second file and the waveform data of the fourth file to a user via a screen of the electronic device;
loading the first file and the third file to a second oscilloscope;
reading the setting values of the first file by the second oscilloscope to determine if the setting values of the second oscilloscope are the same as the setting values of the first file by comparison;
resetting the setting values of the second oscilloscope to be the same as the setting values of the first file; and
displaying the test data of the third file to the user via a screen of the second oscilloscope.

15. An electronic device, comprising:
a non-transitory storage medium;
at least one processor; and
one or more modules that are stored in the non-transitory storage medium; and are executed by the at least one processor, the one or more modules comprising instructions to:
acquire setting values of a first oscilloscope, and storing the setting values into a first file and also into a second file;
acquire test data resulting from test of an electronic signal from the first oscilloscope, and storing the test data into a third file, wherein the test data comprises numerical electrical quantities of the electronic signal;
acquire waveform data resulting from test of the electronic signal from the first oscilloscope, and storing the waveforms into a fourth file;
combine the first file, the second file, the third file, and the fourth file into a combined file; and
storing the combined file into the non-transitory storage medium

16. The electronic device according to claim 15, wherein the electronic device is the first oscilloscope.

17. The electronic device according to claim 15, wherein the setting values comprise a trigger and a sample rate of acquiring electronic signals, a record length and a resolution of the acquired electronic signals.

18. The electronic device according to claim 15, before the storing step, further comprising:
encrypting the combined file.

19. The electronic device according to claim 15, wherein the first file and the third file are in a .WFM format or a .CSV format, and the second file and the fourth file are in a .BMP format, or a .XLS format.

20. The electronic device according to claim 19, wherein the one or more modules further comprise instructions to:
display the setting values of the second file and the waveform data of the fourth file to a user via a screen of the electronic device;
load the first file and the third file to a second oscilloscope;
read the setting values of the first file by the second oscilloscope to determine if the setting values of the second oscilloscope are the same as the setting values of the first file by comparison;
reset the setting values of the second oscilloscope to be the same as the setting values of the first file; and
display the test data of the third file to the user via a screen of the second oscilloscope.
